(19) United States
(12) Patent Application Publication
(10) Pub. No.: US 2004/0206144 A1
(43) Pub. Date: Oct. 21, 2004

(54) Chelated plant micronutrients

(76) Inventors: Alfred Mitschker, Odenthal (DE); Ralf-Johann Moritz, Neuss (DE); Adam Nawrocki, Poznan (PL)

Correspondence Address: LANXESS CORPORATION, PATENT DEPARTMENT/ BLDG 14, 100 BAYER ROAD, PITTSBURGH, PA, 15205-9741, US

(21) Appl. No.: 10/684,925

(22) Filed: Oct. 14, 2003

(30) Foreign Application Priority Data
Oct. 15, 2002 (DE) 10248022.2

(51) Int. Cl. C05D 1/00

(52) U.S. Cl. 71/31

(57) ABSTRACT

The present invention relates to chelated plant micronutrients of the sodium, potassium, sodium/ammonium or potassium/ammonium salts of N-(1,2-dicarboxyethyl)-D,L-aspartic acid and their mixtures with metal ions selected from the group of the inorganic or organic zinc, manganese, iron(II), iron(III) or copper(II) compounds, and to a process for the preparation of these chelated micronutrient fertilizers.

### BACKGROUND

The present invention relates to chelated plant micronutrients comprising the reaction product of the sodium, potassium, sodium/ammonium or potassium/ammonium salts of N-(1,2-dicarboxyethyl)-D,L-aspartic acid and their mixtures with metal ions selected from the group of the inorganic or organic zinc, manganese, iron(II), iron(III) or copper(II) compounds, and to a process for the preparation of these chelated micronutrient fertilizers.

Micronutrients such as iron, copper, zinc and manganese are applied in order to ensure proper plant growth. Micronutrients in chelated form are taken up better by the plants, and deficiency, which leads to reduced yields, is compensated for.

The use of metal ions in chelated form which are prepared with suitable complexing agents with high stability constants is already known from the prior art. Chelated metal ions ensure a rapid uptake and translocation within the plant under different growth conditions, such as soil pH, interaction between soil components, climatic conditions, bicarbonate content, redox potential and other parameters.

Chelated iron(II), iron(III), manganese, copper and zinc ions are used in the form of individual trace elements or in the form of mixtures and as additives for NPK complete or compound fertilizer (NPK=nitrogen-phosphorus-potash).

For example, the patent DE-A 3 517 102 discloses a liquid fertilizer comprising chelated iron(III), manganese, copper, zinc or cobalt in the form of nitrates having a pH of 4 to 8 and a concentration of 40.3% up to 62.7% of the dry matter. In the abovementioned prior art, the chelating agents nitrilotriacetic acid (NTA), ethylenediaminotetraacetic acid (EDTA), diethylenetriaminopentaacetic acid (DTPA), N-hydroxyethylethylenediaminotriacetic acid (HEEDTA), ethylenediamine-di(o-hydroxyphenylacetic acid) (EDDHA) are used separately or in combination with their sodium, potassium and ammonium salts in a molar ratio of metal to chelating agent of at least 0.1:1.0 to 5:1, preferably 0.8:1 to 2.5:1.0.

Most of the synthetic chelating agents mentioned in the prior art are not biodegradable and, accordingly, accumulate in soils and water courses.

DE-A 1 0219 037 describes a process for the preparation of ammonium/metal salts of iminodisuccinic acid and their possible use as micronutrient fertilizers. However, it lacks any suggestion that the divalent, trivalent or tetravalent alkali metal or alkali metal/ammonium mixed salts of N-(1,2-dicarboxyethyl)-D,L-aspartic acid or their mixtures meet the demands of a biodegradable micronutrient fertilizer particularly well.

It was therefore an object of the invention to provide the plants with plant micronutrients in chelated form, to bind the micronutrients in chelated form and to provide the plants with sufficient amounts of the latter, combined with as high as possible a biodegradability of the chelating agents.

### SUMMARY OF THE INVENTION

The invention relates to a composition comprising a chelated plant micronutrient including the reaction product of (i) a salt component selected from the group consisting of sodium salts of N-(1,2-dicarboxyethyl)-D,L-aspartic acid, potassium salts of N-(1,2-dicarboxyethyl)-D,L-aspartic acid, sodium/ammonium salts of N-(1,2-dicarboxyethyl)-D,L-aspartic acid, potassium/ammonium salts of N-(1,2-dicarboxyethyl)-D,L-aspartic acid, and mixtures thereof with (ii) a metal ion component selected from the group of the inorganic zinc, organic zinc, manganese, iron(II), iron(III) compounds, copper(II) compounds, and combinations thereof.

In one embodiment, the invention relates to a process for making a liquid micronutrient comprising (a) chealating (1) a complexing agent A having an imino group and polycarboxyl groups with (2) an inorganic compound B of a chloride, nitrate, acetate, sulphate, carbonate, hydroxide or oxids of the polyvalent metal ions of iron, manganese, copper or zinc, and (b) adding an inorganic acid or an organic acid, and thereby forming the liquid micronutrient.

In another embodiment, the invention relates to a process for preparing a solid chelating plant micronutrient comprising drying a liquid micronutrient in a spray drier, and thereby forming the solid chealating plant nutrient, such that the liquid micronutrient is prepared by (a) chealating (1) a complexing agent A having an imino group and polycarboxyl groups with (2) an inorganic compound B of a chloride, nitrate, acetate, sulfate, carbonate, hydroxide or oxids of the polyvalent metal ions of iron, manganese, copper or zinc, and (b) adding an inorganic acid or an organic acid, and thereby forming the solid chealating plant micronutrient.

In another embodiment, the invention relates to a method for fertilizing a plant comprising treating a plant with a composition comprising a chelated plant micronutrient including the reaction product of (i) a salt component selected from the group consisting of sodium salts of N-(1,2-dicarboxyethyl)-D,L-aspartic acid, potassium salts of N-(1,2-dicarboxyethyl)-D,L-aspartic acid, sodium/ammonium salts of N-(1,2-dicarboxyethyl)-D,L-aspartic acid, potassium/ammonium salts of N-(1,2-dicarboxyethyl)-D,L-aspartic acid, and mixtures thereof with (ii) a metal ion component selected from the group of the inorganic zinc, organic zinc, manganese, iron(II), iron(III) compounds, copper(II) compounds, and combinations thereof, and thereby treating the plant.

These and other features, aspects, and advantages of the present invention will become better understood with reference to the following description and appended claims.

### DESCRIPTION

The object of the invention is achieved by providing the plants to be treated with chelated micronutrients comprising the divalent, trivalent or tetravalent alkali metal or alkali metal ammonium mixed salts of N-(1,2-dicarboxyethyl)-D,L-aspartic acid or their mixtures as compound A and polyvalent metal ions selected from the group of Fe(III), Fe(II), Mn, Cu or Zn as compound B, as well as conventionally used additives.

The chelated plant nutrients are to be at least about 70.0% biodegradable over a period of 28 days as specified in OECD Guideline No. 301 E. They are therefore outstandingly suitable for fertilizing plants, in particular useful plants.

The invention preferably relates to compounds of the formula A

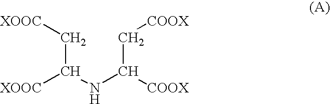

where

X represents potassium, sodium, ammonium or hydrogen and the degree of substitution for potassium and/or sodium is in the range from 2 to 4, preferably 3.5 to 4, and the degree of substitution for hydrogen and/or ammonium in the range from 0 to 2, preferably 0 to 0.5.

This results for example in the following substitution patterns: 3 X are sodium and 1 X is hydrogen or 4 X are sodium or 3 X are sodium and 1 X is ammonium or 3 X are potassium and 1 X is hydrogen or 4 X are potassium or 3 X are potassium and 1 X is ammonium or 2 X are potassium and 1 X is ammonium and 1 X is hydrogen.

Preferred compounds B are in accordance with the invention carbonates, chlorides, sulphates, oxides, hydroxides, acetates and nitrates of the metals iron(III), iron(II), manganese, copper and zinc.

Preferred in accordance with the invention is a molar ratio between the chelating agent A and the metal ion B in the range from about 1.3-0.8 to about 1.0-0.9. In one embodiment, the complexing agent and the metal ion are at a molar ratio ranging from about 1.0:0.8 to about 1.0:0.98.

The chelated micronutrients according to the invention are prepared in liquid or else in solid form and optionally contain conventionally used additives.

The liquid products according to the invention contain from about 1.0 to about 6.0% by weight of the micronutrient, the preferred molar ratio to the chelating agent being from about 0.95 to about 1.0.

The solid products according to the invention contain from about 5.0 to about 14.0% by weight of the micronutrient, the preferred molar ratio to the chelating agent being from about 0.95 to about 1.0.

Moreover, the chelated micronutrients according to the invention may contain other micronutrients which are used in agriculture, horticulture or hydroponics, such as calcium, magnesium, boron, molybdenum or cobalt.

It has been found that the chelated micronutrients according to the invention can be applied as individual chelates or mixtures thereof with other known complex-forming compounds from the series of the aminopolycarboxyl compounds, polyamino-carboxyl compounds, poly- and bicarboxyl compounds, hydroxypolycarboxyl compounds, hydroxypolyaminocarboxyl compounds and, if appropriate, as a constituent of NPK complete and compound fertilizers, which widens their field of application and increases their efficacy.

Preferred complete fertilizers are nitrogen fertilizers such as for example UAN-solution 30.0%, phosphorus fertilizers such as for example MAP or DAP or potash fertilizers such as for example MOP, SOP, KNO₃ or combinations thereof.

It is preferred in accordance with the invention for the chelated plant micronutrient additionally to contain wetting agents or adhesives. Wetting agents or adhesives which are preferred in accordance with the invention are Cycocel®, lignosulfonates or gluconates.

The present invention furthermore relates to a process for the preparation of the finished products in solid or liquid form.

Chelating is effected by reaction of the complexing agent A having an imino group and polyhydroxyl groups and an inorganic compound B of a chloride, nitrate, acetate, sulfate of the polyvalent metal ions, of iron, manganese, copper or zinc, or said complexing agent A is reacted with an inorganic compound C of a hydroxide, carbonate or oxide of the same polyvalent metal ions with addition of inorganic or organic acids. Preferred acids for the purposes of the present invention are hydrochloric acid, sulfuric acid, nitric acid or acetic acid.

In order to convert the resulting products into solid form, the liquid micronutrient fertilizers are dried in a spray-drier. To this end, the liquid products are advantageously first filtered and then sprayed into a spray tower at a pressure ranging from about 15 to about 60 bar, preferably from about 35 to about 45 bar, using suitable nozzles. The inlet temperature of the spray tower is from about 100 to about 300° C., preferably from about 120 to about 250° C., and the outlet temperature is from about 50 to about 150° C., preferably from about 70 to about 120° C. This gives almost dust-free microgranules with a particle size of from about 50 to about 400 μm, preferably from about 80 to about 300 μm. It has proved advantageous to cool the microgranules as they are obtained to approx. about 30° C. and to condition them with an antiadhesive. Products which can be used for this purpose are, for example, those of the Hostapur® series of products.

The micronutrient can be applied in agricultural applications, horticulture applications. Possible ways of applying the liquid product or solid product according to the invention include foliar sprays, soil application, hydroponics and fertigation.

The invention is further described in the following illustrative examples in which all parts and percentages are by weight unless otherwise indicated.

### EXAMPLES

### Example 1

23 ml of a stirred 34% tetrasodium N-(1,2-dicarboxyethyl)-D,L-aspartate solution were treated at 40° C. with 20 ml of an 18.0% zinc chloride solution.

Following reaction for one hour after addition of 0.3% lignosulfonate as adhesive, a storage-stable transparent solution was obtained. The Zn content was 3.74% by weight.

### Example 2

19.6 ml of a stirred 34% tetrasodium N-(1,2-dicarboxyethyl)-D,L-aspartate solution were treated dropwise at 60° C. with 20 ml of a 20% manganese(II) nitrate solution.

After 2 hours of reaction at 60° C., 0.5% Cycocel® was added as wetting agent, whereby a storage-stable orange transparent solution was obtained.

The Mn content was 2.9% by weight (w/w).

### Example 3

12.9 ml of a stirred 47.0% ammonium dipotassium N-(1,2-dicarboxyethyl)-D,L-aspartate solution were treated at 40° C. with 20 ml of a 27.0% copper(II) nitrate solution.

After 2 hours of reaction at 40° C., 0.5% Cycocel® was added as wetting agent, whereby a storage-stable blue transparent solution was obtained.

The Cu content was 3.8% by weight.

### Example 4

20 ml of a stirred 12.0% iron(III) nitrate solution were treated at 40° C. with 11.5 ml of a 34% tetrasodium N-(1,2-dicarboxyethyl)-D,L-aspartate solution.

After reaction for 2 hours with exclusion of light at 40° C., 0.5% Cycocel® and 0.5% lignosulfonate were added as wetting agent and adhesive, respectively, whereby a storage-stable dark green transparent solution was obtained. The Fe(II) content was 2.22% by weight.

### Example 5

20 ml of a stirred 12.0% iron(III) nitrate solution were treated at 60° C. with 11.5 ml of a 34% tetrasodium N-(1,2-dicarboxyethyl)-D,L-aspartate solution.

After reaction for 1 hour, 0.5% of oxidant as well as 0.5% of Cycocel® and 0.5% of gluconate as wetting agent and adhesive, respectively, were added, and stirring was continued for 1 hour.

The final solution was a storage-stable transparent dark red liquid. The Fe(III) content was 2.2% by weight.

### Example 6

393.5 ml of a stirred 34.0% tetrasodium N-(1,2-dicarboxyethyl)-D,L-aspartate solution were treated at 60° C. with 45 ml of a 20.0% zinc nitrate solution, 33.7 ml of a 27.0% copper(II) nitrate solution, 310.5 ml of a 12.0% iron(III)nitrate solution, 133.8 ml of a 20.0% manganese nitrate solution, 13.7 g of boric acid and 60.8 g of magnesium nitrate.

After reaction for 2 hours at 60° C., a storage-stable transparent dark green solution was obtained.

The solution contained:

| | |
|---|---|
| Zn | 0.3% |
| Cu | 0.3% |
| Fe | 1.1% |
| Mn | 0.8% |
| B | 0.2% |
| MgO | 0.8% |

All percentages are by weight.

### Example 7

23 ml of a 34,0% tetrasodium N-(1,2-dicarboxy-ethyl)-D,L aspartate solution and 2,39 g zinc oxide (79.4% ZnO) was treated at 40° C. with 7.2 g of nitric acid 55.0%.

After reaction for 2 hours the solution was filtrated whereby a storage-stable transparent liquid was obtained. The Zn content was 4.65% by weight.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is

1. A composition comprising a chelated plant micronutrient
including the reaction product of (i) a salt component selected from the group consisting of sodium salts of N-(1,2-dicarboxyethyl)-D,L-aspartic acid, potassium salts of N-(1,2-dicarboxyethyl)-D,L-aspartic acid, sodium/ammonium salts of N-(1,2-dicarboxyethyl)-D,L-aspartic acid, potassium/ammonium salts of N-(1,2-dicarboxyethyl)-D,L-aspartic acid, and mixtures thereof with (ii) a metal ion component selected from the group of the inorganic zinc, organic zinc, manganese, iron(II), iron(III) compounds, copper(II) compounds, and combinations thereof.

2. The composition according to claim 1, wherein the
complexing agent and the metal ion are at a molar ratio ranging from about 1.0:0.8 to about 1.0:0.98.

3. The composition according to claim 1, wherein the
micronutrient is present in liquid form and contains from about 1.0 to about 6.0%, by weight of the metal ion component.

4. The composition according to claim 1, wherein the
micronutrient is present in solid form and contains from about 5.0 to about 14.0%, by weight of the metal ion component.

5. The composition according to claim 1, wherein the
micronutrient is applied in an application selected from the group consiting of agricultural applications, horticulture applications, hydroponic applications and fertigation applications.

6. The composition according to claim 1, wherein the
micronutrient is biodegradable in accordance with OECD guidelines.

7. The composition according to claim 1, wherein the
micronutrient further comprises a micronutrient selected from the group consisting of agricutural micronutrients, horticultural micronutrients, hydroponic micronitrients, fertigation micronutrients, and combinations thereof.

8. The composition according to claim 7, wherein the additional
micronutrient is selected from the group consisting of magnesium, boron, molybdenum, calcium, cobalt, and mixtures thereof.

9. The composition according to claim 1, wherein the micronutrient further comprises at least one complexing agent selected from the group consisting of aminopolycarboxyl compounds, polyaminocarboxyl compounds, polycarboxyl compounds, hydroxypolyaminocarboxyl compounds, hydroxypolycarboxyl compounds, and combinations thereof.

10. The composition according to claim 1, wherein the
micronutrient further comprises a NPK fertilizer.

11. The composition according to claim 10, wherein
the additional fertilizer is selected from the group consisting of nitrogen fertilizers, phosphorus fertilizers, potash fertilizers, and combinations thereof.

12. The composition according to claim 1, wherein the
micronutrient further comprises a component selected from the group consisting of wetting agents, adhesives, and combinations thereof.

13. A process for making a liquid micronutrient comprising (a)
chealating (1) a complexing agent A having an imino group and polycarboxyl groups with (2) an inorganic compound B of a chloride, nitrate, acetate, sulphate, carbonate, hydroxide or oxids of the polyvalent metal ions of iron, manganese, copper or zinc, and (b) adding an inorganic acid or an organic acid, and thereby forming the liquid micronutrient.

14. A process for preparing a solid chelating plant micronutrient comprising drying a liquid micronutrient in a spray drier, and thereby forming the solid chealating plant nutrient,
wherein the liquid micronutrient is prepared by (a) chealating (1) a complexing agent A having an imino group and polycarboxyl groups with (2) an inorganic compound B of a chloride, nitrate, acetate, sulfate of the polyvalent metal ions of iron, manganese, copper or zinc, or (b) said complexing agent A is reacted with an inorganic compound C of a hydroxide, carbonate or oxide of the same polyvalent metal ions with adding an inorganic acid or an organic acid.

15. A method for fertilizing a plant comprising: treating a plant with a composition comprising a chelated plant micronutrient including the reaction product of (i) a salt component selected from the group consisting of sodium salts of N-(1,2-dicarboxyethyl)-D,L-aspartic acid, potassium salts of N-(1,2-dicarboxyethyl)-D,L-aspartic acid, sodium/ammonium salts of N-(1,2-dicarboxyethyl)-D,L-aspartic acid, potassium/ammonium salts of N-(1,2-dicarboxyethyl)-D,L-aspartic acid, and mixtures thereof with (ii) a metal ion component selected from the group of the inorganic zinc, organic zinc, manganese, iron(II), iron(III) compounds, copper(II) compounds, and combinations thereof, and thereby treating the plant.
